(19) United States
(12) Patent Application Publication
(10) Pub. No.: US 2013/0117468 A1
(43) Pub. Date: May 9, 2013

(54) SYSTEM AND METHOD FOR RECEIVING AND SYNCHRONIZING CONTENT ON A COMMUNICATION DEVICE

(71) Applicants: Alex D. Ibasco, Makati City (PH); Eduardo Ramon G. Joson, Makati City (PH); Valenice G. Balace, Makati City (PH); Aames Crispin S. Aguas, Makati City (PH); Jose Lorenzo Losantas, Makati City (PH); William Emmanuel S. Yu, Makati City (PH)

(72) Inventors: Alex D. Ibasco, Makati City (PH); Eduardo Ramon G. Joson, Makati City (PH); Valenice G. Balace, Makati City (PH); Aames Crispin S. Aguas, Makati City (PH); Jose Lorenzo Losantas, Makati City (PH); William Emmanuel S. Yu, Makati City (PH)

(73) Assignee: SMART HUB PTE. LTD., Singapore (SG)

(21) Appl. No.: 13/809,323

(22) PCT Filed: Jul. 7, 2011
(86) PCT No.: PCT/SG11/00241

§ 371 Date: Jan. 9, 2013

(30) Foreign Application Priority Data
Jul. 9, 2010 (SG) 201004999-7

(51) Int. Cl. H04L 29/08

(52) U.S. Cl. CPC H04L 67/26
USPC 709/248

(57) ABSTRACT

A system and method for receiving and synchronizing content on a communication device that includes a source configured to provide a first content to the communication device via a first channel; a host of the communication device configured to push a second content to the communication device via a second channel, the second channel separate and independent from the first channel; wherein in operation, the first content and second content are synchronized at the communication device via a presentation layer of the communication device is disclosed. The system and method are particularly advantageous to provide a seamless experience to a user.

### FIELD OF THE INVENTION

The present invention relates to a system and method for receiving and synchronizing content on a communication device. The system and method are particularly suited, but not limited to push content that is relevant to broadcast content such as a radio broadcast which a communication device user is tuned to and will be described in this context.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Current prior art systems and methods of providing radio broadcast content are generally homogenous, i.e. any regular content and pushed content are sent to a user via a single channel. Internet radio, for instance, delivers both regular content (such as songs, tunes etc) and pushed content (such as playlist, advertisement etc) through the Internet Protocol (IP) network. In light of the utilization of the single channel, the regular content must be differentiated from the pushed content via some form of encoding or embedded code during transmission of the content. Subsequently, the encoded content and embedded content are decoded or unpacked at the receiving end. Such encoding/embedding and subsequent decoding/unpacking requires certain amount of bandwidth and in addition may affect the cost effectiveness of the system.

The present invention seeks to provide a system and method that alleviates the above mentioned drawbacks.

### SUMMARY OF THE INVENTION

In accordance with a first aspect of the present invention, there is provided a system for receiving and synchronizing content on a communication device comprising a source configured to provide a first content to the communication device via a first channel; a host of the communication device configured to push a second content to the communication device via a second channel, the second channel separate and independent from the first channel; wherein in operation, the first content and second content are synchronized at the communication device via a presentation layer of the communication device.

Preferably, the first content and second content are synchronized at the communication device based on a synchronization cue that is generated by the source of the first content to the communication device;

Preferably, the system includes a user profile database containing information specific to the user of the communication device, the profile database adapted to push user specific information to the second channel to be appended to the second content;

Preferably, the source is a radio broadcast; analogue TV; digital TV; or satellite feed.

Preferably, the host and the communication device is a telecommunications carrier and a mobile device respectively.

Preferably, the system comprises a location-based service to push location information relating to the first content to the communication device from the second channel.

In accordance with a second aspect of the present invention, there is provided a method for receiving and synchronizing content on a communication device comprising the steps of: receiving at the communication device a first content from a source via a first channel; receiving at the communication device a second content from a host of the communications device via a second channel; the second channel separate and independent from the first channel; and synchronizing the first content and the second content via a presentation layer of the communication device.

Preferably the step of synchronization is facilitated by a synchronization cue that is generated by the source of the first content to the communication device.

Preferably the method includes the step of receiving from a user profile database, information specific to the user of the communication device and appending the information specific to the user of the communication device to the second content prior to synchronization.

Preferably the source is a radio broadcast; analogue TV; digital TV; or satellite feed.

Preferably the host and the communication device is a telecommunications carrier and a mobile device respectively.

Preferably the method includes a step of checking if the received second content is an event identifier, a synchronization cue or details on the song being played prior to synchronizing the first content and the second content.

In accordance with a third aspect of the invention there is provided a computer program product comprising a plurality of data processor executable instructions that when executed by a data processor in a communication device causes the communication device to perform the method as detailed in the second aspect of the invention.

### BRIEF DESCRIPTION OF THE DRAWINGS

The present invention will now be described, by way of example only, with reference to the accompanying drawings, in which:

FIG. 1 is a schematic representation of an embodiment of a system of receiving and synchronizing content in accordance with an embodiment of the present invention.

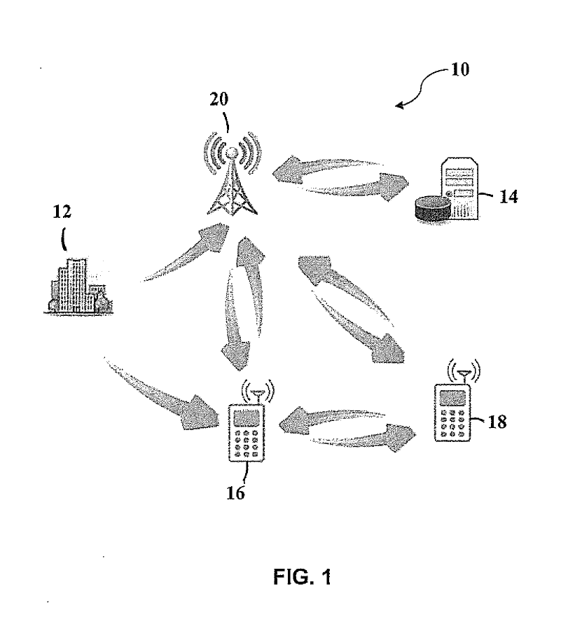

FIG. 2 is a flow diagram of the delivery of regular and push content to a communication device in accordance with an embodiment of the present invention.

FIG. 3 is a flow diagram of illustrating the checking of pushed content at the presentation level of a communication device according to the both embodiments of the invention.

FIG. 4 illustrates a possible user-interface implemented on a communication device.

### DETAILED DESCRIPTION

In accordance with a first embodiment of the invention there is a system for receiving and synchronization content 10.

The system 10 comprises a source 12, a database 14, and a host communications network 20 for supporting communication devices 16, 18.

Source 12 is a radio broadcaster having a first channel. The first channel is a regular frequency band of source 12. The first channel is configured to broadcast a first content to the communication device 16 via a particular FM bandwidth. The first content may be regular or broadcast content such as songs and tunes. Source 12 is further configured to send a second content to host communications network 20 via an application as known to a person skilled in the art. The second content is typically push content such as playlists, a cue that a particular song is being played, promotional advertising, and audience interaction tools etc. Such audience interaction tools are typically interfaces between the host communications network 20 and the source 12, and will be elaborated further in the context of the operation of the system 10 below.

Database 14 is a user profile database used to store subscribers' information and location information. In addition, the database 14 may be configured to provide a location-based service.

Communication devices 16, 18 are typically mobile devices, although they may be any communication device satisfying the minimum technical specification as follows:

GSM with Short message service (SMS), Multi-Media messaging service (MMS) and Extended Messaging Service (XMS);

General packet radio service (GPRS); Enhanced Data rates for GSM Evolution (EDGE) Universal Mobile Telecommunications System (UMTS).

The communication devices 16, 18 are capable of receiving at least two communication signals of different technologies and protocols.

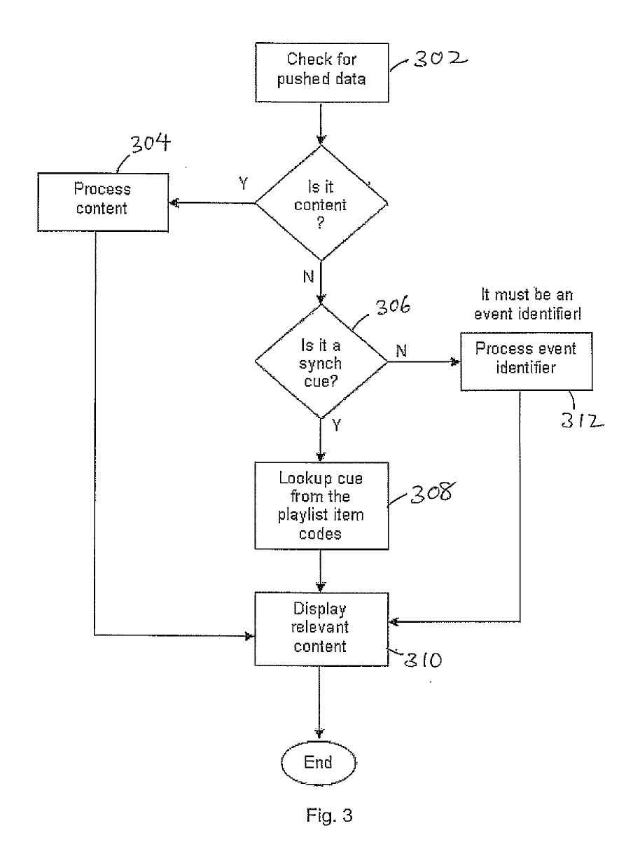

Further, the communication devices 16, 18 require installed software for the purpose of receiving and synchronizing the first and second content. The software is integrated in the communication devices 16, 18. The software is responsible for the seamless environment at the presentation level of the communication devices. A simple flowchart of the software is presented in FIG. 3 and the workings of the same will be described in the context of the operation of the system below.

The invention will now be described in the context of an example of its operation wherein the communication devices 16, 18 are mobile devices hosted by host communications network 20. Host communications network 20 is typically a mobile communications carrier capable of supporting both GSM and IP network (example GPRS). In the example communication device 16, 18 are enabled with FM tuners.

Radio (FM) broadcaster 12 is playing some tunes to which communication device 16 is currently tuned in to. As each tune in the playlist is played, FM broadcaster 12 sends push content to host communication network 20 through an IP network.

The push content that the FM broadcaster 12 sends to host communication network 20 contains, among other things, details on the song being played, such as name of artist, title of song, duration of the song, event identifier, advertisements etc.

Host communication network 20 pushes the push content to the mobile device 16. This is via a second channel which is independent and distinct from the first channel broadcasting the songs, tunes. The second channel may be either the GSM network or the IP network of the host communication network 20. In addition to the push content, any additional push content which may be made as a consequence of the push content can be sent.

For example, if the push content is an event identifier indicating that currently the station is airing an advertisement about a specific brand of shoes, such additional push content may be in the form of images or a movie tagged to the specific brand of shoes. The user of mobile device 16 may thus augment the listening experience with appropriate visuals.

To further enhance the user experience and increase the relevance of the content being pushed by host communication network 20 to mobile device 16, the host communication network 20 retrieves additional push content from the user profile database 14 specific to the user of the mobile device 16. Such additional push content from user profile database 14 is then combined with the push content (e.g. playlist) from the FM broadcaster 12. The host communication network 20 then proceeds to push to mobile device 16 the combined push content resulting from the aforementioned combination, subjected to certain rules and other operator-defined criteria. An example of the rule is as follows:

Suppose the FM broadcaster 12 maintains a playlist for the day which is aired accordingly. The song currently being aired could be “Song A” which is received by the mobile device 16 as regular content. As “Song A” is played, the FM broadcaster 12 sends a cue or a synchronization data as push content. The playlist, which is assumed to have been sent as push content earlier, is cross-referenced with the cue or synchronization data so that as “Song A” is played, the phone will display its title, the name of the artist, and other relevant information. (This is an example of the rule, because information other than the song title, name of the artist, etc. could be displayed depending on the rule in place).

For the purpose of illustration, the host telecommunications network 20 has an existing agreement with a record store and based on the synchronized data, could make suggestions through the mobile device 16 that an album containing “Song A” is available for purchase. The user of mobile device 16 can simply click on “purchase” and the purchase transaction will be made, provided that the subscriber identification module (SIM) in the mobile device 16 is coupled with an electronic money product. (This is an example of an operator-defined criterion). Instead of the suggestion to buy an album, another operator-defined criteria is an event related to “Song A” which can be combined with a location-based service or a subscriber profiling database. For instance, several users may be tuned in to the same station and listening to the same song, but only a handful of them are in close proximity to a mall event where the artist who sang “Song A” is having a meet-and-greet visit. The meet-and-greet visit could be made known to these users.

With the above arrangement, host communication network 20 can provide the mobile device 16 with a heads up or preview of what is to come. Based on the pushed content from the host communication network 20, mobile device 16 could further employ an adaptive system which could take into account subsequent actions of the user of mobile device 16 to deliver more relevant content. The adaptive system is one that adapts to the user based on the historic actions of the user. The adaptive system profiles the user through his previous interactions with the system, and the system adapts accordingly. For instance, if a user does not seem inclined to participate in opinion polls fielded by a radio station, this inclination can be learnt by the system through his past actions, such as choosing a “do not participate” button from among the options (“yes”, “no”, and “do not participate”). Upon establishing that the user does not want to be bothered by opinion polls, the system can turn off opinion polls and inform the user that it can be subsequently turned on if he so desires, giving a general instruction of how to turn the option on. Meanwhile, without the opinion polls, the system will continue to present the user with other options, such as requests and dedications. If the user is deemed by the adaptive system to be someone who likes to use the requests and dedications feature, then this interface will replace the polls mentioned earlier.

Upon receiving the content from the host communication network 20 and the broadcaster 12, the user of the mobile device 16 is able to listen to songs, tunes from the broadcaster 12 while at the same time receives information about the song or tune such as name of artist, title of song duration etc from the host communication network 20. It is to be appreciated that while a playlist could already predict the next song or tune to be played, there is no guarantee that the second channel (in this case the channel for communicating between the host communication network 20 with the mobile device 16) is synchronized with the first channel (in this case the broadcaster 12). The above problem may be addressed by a synchronization cue that is generated by the FM broadcast 12 as each song is being played and transmitted to mobile device 16 through host communication network 20.

The system 10 may be further configured to interact with the user of mobile device 16. As an example, a broadcaster from the FM station 12 may wish to field a quick poll to any listener(s) tuned in, one of them being the user of mobile device 16. Instead of the usual phone-in callers and SMS polls, the broadcaster can simply send out an actionable object that would ask those currently tuned in with the question said disc jockey wanted to field. The user of mobile device 16 then, through the mobile device 16, could simply respond in the affirmative or the negative. The user of mobile device 16 may also opt not to participate and simply dismiss the poll.

The user of mobile device 16 is further given the option to share either the regular content from the FM broadcast 12 or the pushed content from the host communication network 20, or both, with the mobile device 18 or any number of such other devices. The sharing of such content may be performed through the communication network 20 or through a direct wired or wireless link-up with the mobile device 18. Sharing could also take place in the form of an invitation to tune in to the same frequency band, an invitation to buy or subscribe to a product, an invitation to participate in a related discussion, and the like via an actionable object.

When the user of mobile device 16 sends an invite to the user of mobile device 18, the user of mobile device 18 will be prompted or informed of the invite as known to a person skilled in the art. When the user of mobile device 18 answers positively to the invite, the mobile device 18's tuner will be temporarily controlled by the actionable object and automatically tuned in to the same frequency band as that which mobile device 16 is tuned in to.

The workings of the audience interaction tool between the first and second channels arising from FM broadcaster 12 and 20 may be illustrated further as follows when the FM broadcaster 12 is accepting requests and dedications.

The state of the art is that users can phone in, send SMS/MMS, send an email, send a letter, or personally drop by the station to make a request. Under the system 10, as the broadcast from the radio is being played, an interface will be presented to the user for making a request or dedication. The interface will be made available only if the station supports accepting request and dedications. If a user wants to dedicate a song to someone, he can use the interface and simply hit the “dedicate this song” button, which then calls up the phone address book from which the user can select the recipients. Upon completing the transaction, the phone will send the dedication request to the radio station for its over-the-air acknowledgement, and at the same time, the radio station through the host communications network 20 can inform the recipient of the dedication that such song has been dedicated to him or her. The person making the dedication also has the option to make his or her identity known or simply remaining anonymous using the same interface. Under this illustration, the broadcast channel broadcast the content while the IP channel of the host communications network 20 informs the recipient of the dedication of the song via, for example, Internet chat messaging etc.

These audience interaction tools are not limited to requests and dedications interface, but also includes other interactive tools such as a listener opinion poll (where users can simply key-in their response to the particular poll), a game (where users are asked to participate in game shows through their phones such as word guessing, Q&A, etc), and others.

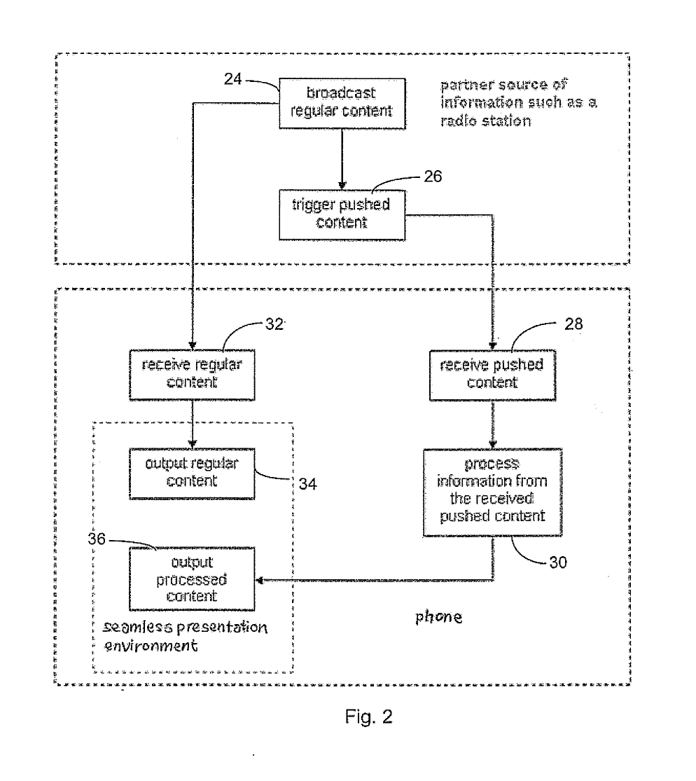

In accordance with a second embodiment of the invention there is a method of providing content to a communication device as depicted in the flow chart of FIG. 2. The method is suited to work with system 10 as described in the first embodiment.

The method handles two types of content—regular content 24 and pushed content 26 from a partner source of information such as a radio broadcaster with a FM channel. Regular content 24 is transmitted directly to a communication device such as a mobile device, which is subsequently received (step 32) by the mobile device. Transmission of regular content is via a first channel, which may be any transmission channel such as Internet Protocol, wireless or wired.

At the same time that the regular content 24 is transmitted to the mobile device, pushed content 26 may be triggered to be transmitted via a second channel which is different from the first channel. For purpose of illustration the second channel is the telecommunications channel which the mobile device is a subscriber to. Pushed content 26 is received (Step 28) by the mobile device. Subsequently, pushed content 26 is processed (step 30). The processing of the pushed content 26 may include user specific information and preference which may be obtained from a similar database or location-based service 14.

Upon the receiving of the contents 24, 26 at the mobile device, there is a seamless presentation layer configured to synchronize the output regular content 34 and the output processed content 36. The presentation layer is concerned with functions such as transformation of data encodings so that the heterogeneous channels may engage in meaningful communication/convergence of content. An example of the transformation of data encodings may be an MP3 digital audio stream being converted to analog audio (PCM audio) upon playback. It is to be appreciated that the regular content 24 is kept separated from the pushed content 26. It is to be also appreciated that the pushed content is related to and dependent on the regular content and may be a function of the regular content.

The above described system 10 provides a convergent platform with a seamless user experience from the point of view of the user of mobile device 16.

In both the embodiments as described above, the software installed at the presentation level of the mobile devices 16 and/or 18 is configured to check for pushed content in the following manner (See FIG. 3).

Upon tuning in to a provider of free-to-air content, in this example an FM station, the phone sends a handshake with the station-side application. Push content will then be pushed to the mobile device 16, also known as the initialization phase. During this initialization phase, the playlist will be sent to the mobile device 16. The playlist is created by the broadcaster at the FM station using the station-side application. Song codes are generated on the fly as the playlist is populated. The playlist is then stored in the local system for broadcasting on air, but the station-side application has access to this playlist. When a playlist is sent out, it includes all pertinent metadata i, such as title, artist, album, and song code among others.

The installed software, which may be a ‘widget’ for the sake of illustration, on the mobile phone 16 first checks for pushed data (step 302). If the pushed data is a playlist, then it is processed and displayed as may be appropriate (step 304). Content could also be further information on the song, a poll question and possible options (usually Boolean options with opt-out or cancel), and others. On the other hand, if the pushed data is not content such as playlist, information on the song etc mentioned above, it is checked if it is a synchronization cue (step 306). If it is a synchronization cue, which could come in the form of some function identifier or header plus the song code, a lookup query will then be made from the playlist (step 308). It is to be noted that a synchronization cue is sent out by the station-side application for every song or item it broadcasts, such that a synchronization cue acts similar to the inter-record gaps in the era of magnetic tape technology. When a match is found between the synchronization cue and the playlist song code, the playlist pointer is updated and the relevant information is displayed, such as the appropriate song title, name of artist, and the like (step 310). When pushed data is neither content nor synchronization cue, then it has to be an event identifier (step 312). This means that the radio station is probably playing an advertisement over the air and not a song. This could also mean that the radio station may be engaged in program filler, such as brief commentaries from the disc jockey and the like. If an advertisement is being played, the phone then displays the relevant visuals for the advertisement. For instance, if an advertisement for the popular soda is being played, the listening experience will be augmented by visuals such as the graphic version of the ad, a slideshow or perhaps a movie. On the other hand, when the station is indulging in program filler such as audience interaction with the broadcaster other content could take the place of the visuals. Such content could be a poll, where users can readily participate and answer the poll questions fielded by the disc jockey over the air.

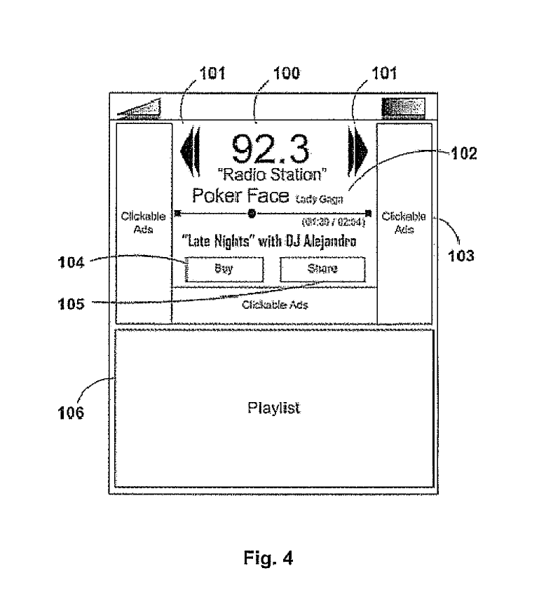

FIG. 4 is a screenshot illustration of an implementation of this invention, where the regular content is a free-to-air content and in this example a broadcast from an FM radio station. A station identification 100, here indicated as its FM frequency (92.3) and station handle or name, “Radio Station”. The interface shows actionable screen objects 101 which when tapped (for a touch phone) or selected (for a keypad-based phone) would tune in to the next station of lower or higher frequency, depending on which object is tapped or selected. Information on the song or tune 102 is currently being played by the station, which could include the title of the song (“Poker Face”) and the name of the artist (“Lady Gaga”). This information is not broadcasted by the FM station through its frequency band. Instead, the secondary channel is used by the station to push this information to the phone.

While a playlist 106 for the day may have already been prepared by the disc jockey and the same information has already been sent to the phone earlier, there is no way for the phone to know that the nth song in the playlist is being played already. Thus, to effect synchronization, a corresponding cue is sent to the phone as the disc jockey plays a song. The phone will then know which song in the preloaded playlist is being played. It will be noted that the cue is sent not through the same channel as that of the free-to-air content, but through a secondary channel which could be an IP network or the GSM network of the host communication network. Since the phone now has a means to know what content/song/tune is currently being aired, it can then push relevant content to the user, such as advertisements 103. These advertisements could be interactive advertisements, which when tapped or selected, could provide the user an interface (a) to know more about the subject being advertised or (b) interact with the advertiser. There could be a further interface 104 for the user to buy merchandise relevant to the song, such as an album. Tapping or selecting the buy option will facilitate over-the-air purchase of the merchandise. Over-the-air payment can likewise be integrated. On the other hand, there could also be a further button for sharing 105 which when tapped or selected would prompt the user to identify the intended recipient. At this point, the phone book can be invoked so the user will have a checklist interface to select the share invitation recipients. This will subsequently cause the device to send a share invitation to the intended recipients, and when said recipients accept the share invite, their respective phones will be automatically tuned in to the frequency band of the radio station shared.

The above further illustrates the seamless environment where it is transparent to the user that the free-to-air content and the other contents pushed to the device are delivered to the device through two distinct and separate channels.

The Applicant has noted that the separation of the first and second channels provide at least the advantage of cost efficiency, because the first channel or the regular content is free-to-air content, such as free radio and TV broadcasts, satellite feeds, and the like. This allowed the operator GSM network to be off-load or unburdened. Instead of these contents passing through the costly network of a host communication network, the mobile device receives the same through freely available channels. The mobile device mashes this content with that of content from the GSM network, i.e. pushed content, and present it to the user in a seamless environment as provided by the FIG. 3.

The described system and method further allows easy content sharing between friends, with the assumption that they tend to like (or are interested in) similar songs/tunes for example. The utilization of two separate channels enables a user to notify/share/dedicate a song being broadcasted via the separate second channel without affecting the quality of the broadcasted song. As the song being played is typically via a broadcast channel, which are typically free-to-air, cost is also reduced from the user's point of view.

It should be appreciated by the person skilled in the art that the invention is not limited to the embodiments described. For example, the invention as described can include the following modifications and/or additions:

The radio broadcaster 12 could be any source of information such as a radio or television broadcaster, cable services, premium content provider and the like, and the channels may include all types of transmission as known to a person skilled in the art.

The communication devices 16, 18 could be used for Internet-based communication, which can be connected to the host communications network 20, but it can likewise connect to a peer through any wired or wireless communications protocol.

The communication devices 16, 18 may be replaceable by any communication device meeting the minimum technical specification. It may further be smart phones.

The host communications network 20 could be any wired or wireless network.

The content which would be pushed may include targeted advertisement Further, such pushed content can be aligned with curated experience or be based on suggestive marketing;

The host communications network 20 may be configured to monitor user behavior to push content purposely to assimilate transaction and functional patterns to marketing campaigns.

The source 12 could be an analog or digital TV or radio broadcast transmission, which could be replaced with any functional equivalent such as a satellite feed.

The host communications network 20 is preferably the telecommunication company network, but which could be replaced with a wireless connection the Internet, an intranet or any connectivity distinct and separate from the first channel.

The profile database 14 with the location-based service can be replaced with any relevant function equivalent, such as a record of previous transactions from the same user or any pattern which could be mined from available records.

The invention may cover other forms of broadcast, including unicast and multicast, coupled and matched with another information delivery channel.

It should be further appreciated by the person skilled in the art that variations and combinations of features described above, not being alternatives or substitutes, can be combined to form yet further embodiments falling within the intended scope of the invention.

1-13. (canceled)

14. A system for receiving and synchronizing content on a communication device comprising:
a source configured to provide a first content to the communication device via a first channel;
a host of the communication device configured to push a second content to the communication device via a second channel, the second channel separate and independent from the first channel; and
an adaptive system arranged to take into account historic actions of the communication device and thereafter profiles the communication device to determine relevant second content to be pushed to the communication device;
wherein in operation, the first content and second content are synchronized at the communication device via a presentation layer of the communication device.

15. The system according to claim 14, wherein the first content and second content are synchronized at the communication device based on a synchronization cue that is generated by the source of the first content to the communication device.

16. The system according to claim 14 further comprising a user profile database containing information specific to the user of the communication device, the profile database adapted to push user specific information to the second channel to be appended to the second content.

17. The system according to claim 14, wherein the source is a radio broadcast; analogue TV; digital TV; or satellite feed.

18. The system according to claim 14, wherein the host and the communication device is a telecommunications carrier and a mobile device respectively.

19. The system according to claim 14, further comprising a location-based service to push location information relating to the first content to the communication device from the second channel.

20. A method for receiving and synchronizing content on a communication device comprising the steps of:
receiving at the communication device a first content from a source via a first channel;
receiving at the communication device a second content from a host of the communications device via a second channel; the second channel separate and independent from the first channel;
profiling the communication device by taking into account historic actions of the communication device and thereafter determine relevant second content to be pushed to the communication device; and
synchronizing the first content and the second content via a presentation layer of the communication device.

21. The method according to claim 20, wherein the step of synchronization is facilitated by a synchronization cue that is generated by the source of the first content to the communication device.

22. The method according to claim 20 further comprising the step of receiving from a user profile database information specific to the user of the communication device and appending the information specific to the user of the communication device to the second content prior to synchronization.

23. The method according to claim 20, wherein the source is a radio broadcast; analogue TV; digital TV; or satellite feed.

24. The method according to claim 20, wherein the host and the communication device is a telecommunications carrier and a mobile device respectively.

25. The method according to claim 20, further comprising a step of checking if the received second content is an event identifier, a synchronization cue or details on the song being played prior to synchronizing the first content and the second content.

26. A computer program product comprising a plurality of data processor executable instructions that when executed by a data processor in a communication device causes the communication device to perform the method of claim 20.
